(19) United States
(12) Patent Application Publication
(10) Pub. No.: US 2025/0355098 A1
(43) Pub. Date: Nov. 20, 2025

(54) METHOD FOR DETECTING DEGRADATION OF A LIDAR SENSOR

(71) Applicant: MERCEDES-BENZ GROUP AG, Stuttgart (DE)

(72) Inventor: Robin HEINZLER, Stuttgart (DE)

(21) Appl. No.: 18/869,412

(22) PCT Filed: Mar. 30, 2023
(86) PCT No.: PCT/EP2023/058402

§ 371 Date: Nov. 26, 2024

(30) Foreign Application Priority Data
May 30, 2022 (DE) 10 2022 001 878.0

(51) Int. Cl. G01S 7/497; G01S 7/48; G01S 7/486; G01S 17/10; G01S 17/931

(52) U.S. Cl. CPC G01S 7/497; G01S 7/4808; G01S 7/486; G01S 17/10; G01S 17/931

(57) ABSTRACT

Degradation of a lidar sensor is detected using lidar pulses emitted by the lidar sensor. Reflections of the emitted lidar pulses are detected by the lidar sensor and an object, from which lidar pulses are reflected, is detected in the surroundings of the lidar sensor. The detected object is tracked over several time cycles. It is determined, considering the distance of the tracked object to the lidar sensor and the geometry of the tracked object, which lidar pulses should be reflected on the object when it is tracked. A failure rate is determined, the failure rate specifying specifies how often an expected reflection is not detected within a predetermined period of time. Based on the failure rate and the distance to the tracked object, a degradation of the lidar sensor is determined.

### BACKGROUND AND SUMMARY OF THE INVENTION

Exemplary embodiments of the invention relate to a method for detecting a degradation of a lidar sensor, as well as to a method for operating a vehicle and/or a robot.

A method for determining a visibility range of a beam-based sensor of a vehicle for surroundings detection is known from DE 10 2018 008 903 A1. Sensor beams with a known intensity are emitted by means of the beam-based sensor, wherein reflections of the sensor beams are detected by means of the sensor and a reflection intensity is evaluated. A measured distance and the reflection intensity are linked to each other, and it is determined whether a visibility range of the sensor is reduced compared to a maximum visibility range of the same.

Exemplary embodiments of the invention are directed to a novel method for detecting a degradation of a lidar sensor and a novel method for operating a vehicle and/or robot.

In the method for detecting degradation of a lidar sensor, according to the invention lidar pulses are emitted by the lidar sensor and reflections of the emitted lidar pulses are detected by the lidar sensor. Furthermore, an object from which lidar pulses are reflected is detected in the surroundings of the lidar sensor, wherein the detected object is tracked over several time cycles. Taking into consideration the distance of the tracked object to the lidar sensor and the geometry of the tracked object, it is determined which lidar pulses should be reflected on the object when it is tracked. Furthermore, a failure rate is determined, which specifies how often an expected reflection is not detected within a predetermined period of time. Based on the failure rate and the distance to the tracked object, a degradation of the lidar sensor is concluded.

In addition to determining a current degradation of the lidar sensor, for example influenced by surroundings influences or contamination, the present method also makes it possible to reliably determine ageing and loss of individual transmitter-receiver pairs of the lidar sensor. This information enables particularly reliable and safe operation of an automatic, in particular highly automatic or autonomously driving vehicle and/or robot, since, on one hand, the current driving style of the vehicle and/or robot can be adjusted to the degradation of the lidar sensor by means of the information and, on the other hand, an ageing state of the lidar sensor can be determined.

In a possible design of the method, a reduction in the range of the lidar sensor is determined as degradation. Thus, the current driving style of the vehicle and/or robot can be adjusted to the current range of the lidar sensor. For example, a travelling speed of the vehicle and/or robot can thus be reduced with increasing degradation of the at least one lidar sensor.

In a further possible design of the method, the failure rate is determined for each receiver pixel of the lidar sensor. This makes it possible that, in the event of partial degradation of the lidar sensor, information determined can furthermore be used reliably for the automatic operation of the vehicle by means of receiver pixels that lie outside a degraded area and a limitation of the automatic operation is thus minimized.

In a further possible design of the method, a comparison of the determined failure rate per receiver pixel with determined failure rates of adjacent receiver pixels depending on the distance to the tracked object is carried out to determine a defect and/or ageing of the respective receiver pixel. In doing so, the reliability of the method can be further increased.

In a further possible design of the method, a range of the lidar sensor is determined from a reflection intensity of the lidar pulses reflected on an object and from the distance of the lidar sensor to the object. Determining the range in this way can be carried out particularly simply, reliably and precisely.

In the method according to the invention for operating a vehicle and/or robot, the surroundings of the vehicle and/or robot are detected by means of at least one lidar sensor and, depending on data detected by means of the lidar sensor, an automatic, in particular highly automatic or autonomous driving operation of the vehicle and/or robot is carried out taking into consideration a degradation of the at least one lidar sensor detected by means of a method described above.

Due to the reliable detection of the degradation of the lidar sensor, the method enables equally reliable operation of the automatic driving vehicle and thus enables an increase in road safety.

In a possible design of the method, a driving speed of the vehicle and/or robot is reduced in automatic driving operation with increasing degradation of the at least one lidar sensor, such that safe operation of the vehicle and thus a high degree of traffic safety can always be enabled depending on the degradation of the lidar sensor.

### BRIEF DESCRIPTION OF THE DRAWING FIGURES

Exemplary embodiments of the invention are explained in more detail below by means of drawings.

Here are shown:

FIG. 1, schematically, a receiver of a lidar sensor when detecting an object at a first distance,

FIG. 2, schematically, the receiver according to FIG. 1 when detecting the object at a second distance reduced in comparison to the first distance,

FIG. 3, schematically, a receiver of a lidar sensor when detecting an object and

FIG. 4, schematically, a failure rate of a receiver of a lidar sensor depending on a distance to a recorded object.

Parts corresponding to one another are provided with the same reference number in all figures.

### DETAILED DESCRIPTION

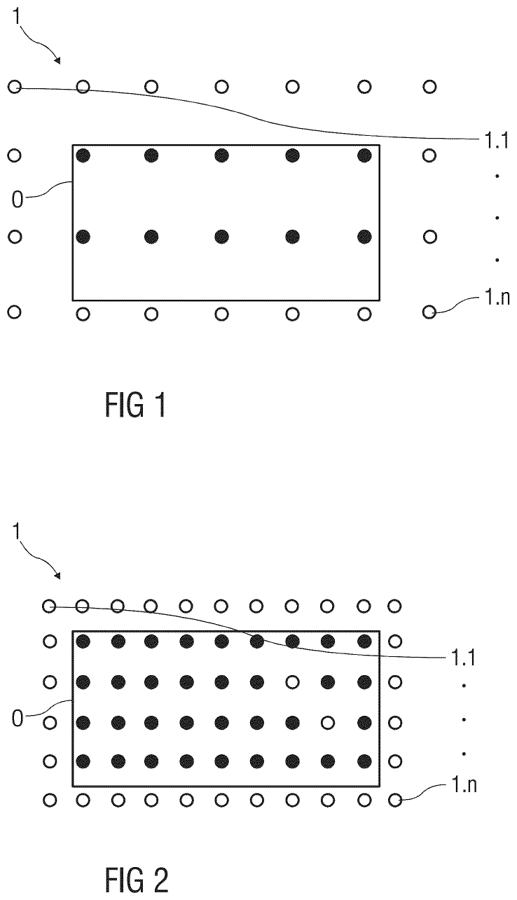

In FIG. 1, a receiver 1 of a lidar sensor is shown schematically upon detecting an object O at a first distance d. FIG. 2 shows the receiver 1 according to FIG. 1 upon detecting the object O at a second distance d, which is reduced in comparison to the first distance d. The distance d is depicted in more detail in FIG. 4.

Lidar sensors scan their surroundings with light in the infrared range and record a distance or a spacing d and a piece of information about backscattered light for each measuring point or receiver pixel 1.1 to 1.n. This information is, for example, the intensity of the backscattered light. Due to the measuring principle, a number of measuring points or receiver pixels 1.1 to 1.n per unit area decreases with greater distance d, since the receiver 1 of the lidar sensor measures in polar coordinates.

Consequently, as shown schematically in FIG. 1, fewer receiver pixels 1.1 to 1.n receive a signal on an object O at a large distance d, for example 150 m, than upon detecting an object O according to FIG. 2, in which the object O has a significantly smaller distance d to the receiver 1. When objects O have been measured several times and tracked over time, a comparison can be carried out as to how often individual receiver pixels 1.1 to 1.n fail, although a signal is expected at receiver pixels 1.1 to 1.n due to the present object dimensions.

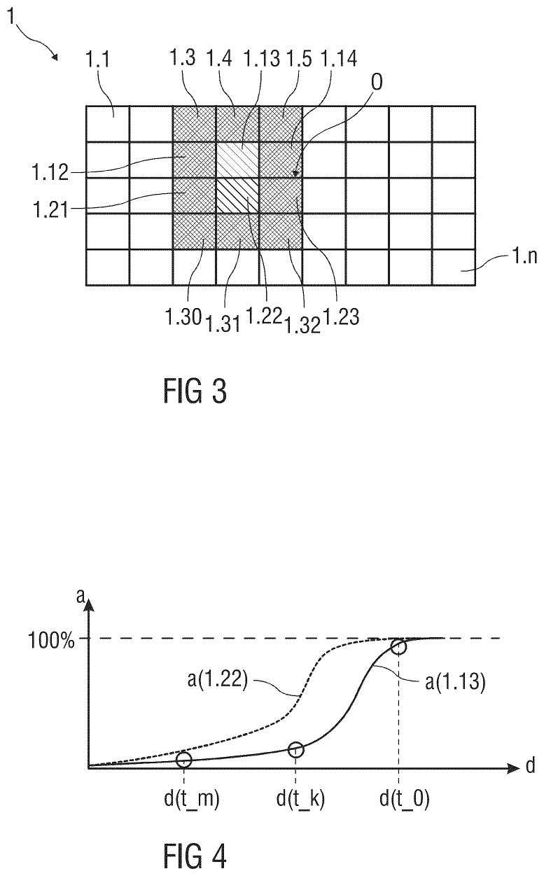

In FIG. 3, a receiver 1 of a lidar sensor is depicted upon detecting an object O. Here, the object O is formed in such a way that it should be detected by the receiver pixels 1.3 to 1.5, 1.12 to 1.14, 1.21 to 1.23 and 1.30 to 1.32. FIG. 4 shows a failure rate a for different receiver pixels 1.1 to 1.n of a lidar sensor depending on the distance d to a detected object O.

If an object O is detected for the first time at a first point in time t_0 and tracked continuously over the further course of time via further points in time t_k up to a further point in time t_m, a failure rate a per receiver pixel 1.1 to 1.n of the lidar sensor can be determined due to a known geometry. Here, the failure rate a can be combined with the distance d of the object O between the first point in time t_0 and the further point in time t_m. The failure rate a depending on the distance d can thus be determined for each receiver pixel 1.1 to 1.n.

A comparison of the determined failure rate a depending on a distance between different receiver pixels 1.1 to 1.n allows conclusions to be drawn about possible defective or aged receiver pixels 1.1 to 1.n. Possible temporary interferences, such as rain or a dirty windscreen of the lidar sensor for example, can here be identified by different accumulations over time.

If the failure rate a is determined in the laboratory depending on the distance d at the beginning of a life cycle of the lidar sensor, these values can be used as a basis for determining temporary or permanent changes.

FIG. 3 shows an example of a deviation between the receiver pixel 1.13 and the defective receiver pixel 1.22 occurring upon detecting the object O. A failure rate a of 100%, depicted in FIG. 4, corresponds to a non-present measurement, i.e. the receiver 1 of the lidar sensor has not recognized any object O.

Determined failure rates a depending on the distance d here allow the following conclusions to be drawn. A correlation between a maximum range of the lidar sensor and the failure rate a emerges according to

$${d}_{max} = β \cdot d ( {t}_{k} ) , when β = f ( a ) , \qquad ( 1 )$$

wherein the factor β can be determined on the basis of laboratory measurements or previous sensor measurements and is dependent on the failure rate a.

Thus, the following emerges, for example,

$${d}_{max} = 1.25 \cdot d ( {t}_{k} ) with a ( d ( {t}_{k} ) ) = 25 \% and β = f ( a ) = f ( 25 \% ) = 1.25 . \qquad ( 2 )$$

Differences in failure rate curves between two different receiver pixels 1.1 to 1.n can here be caused permanently due to defective or aged electronic components and/or optical components and/or temporarily due to a dirty front screen of the lidar sensor or external interference, such as rain or fog for example. This is depicted in FIG. 4 for the failure rate a (1.22) of the defective receiver pixel 1.22 and the failure rate a(1.13) of the adjacent receiver pixel 1.13.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-7. (canceled)

8. A method comprising:
emitting, by a lidar sensor, lidar pulses;
detecting, by the lidar sensor, reflections of the emitted lidar pulses;
detecting an object, from which the emitted lidar pulses are reflected, in surroundings of the lidar sensor;
tracking the detected object over several time cycles;
determining, considering a distance of the detected object to the lidar sensor and a geometry of the detected object, which of the emitted lidar pulses should be reflected on the detected object when the detected object is tracked;
determining a failure rate specifying how often an expected reflection of the emitted lidar pulses reflected on the detected object is not detected within a predetermined period of time; and
determining, based on the failure rate and the distance to the detected object, a degradation of the lidar sensor.

9. The method of claim 8, wherein the determined degradation of the lidar sensor is a reduction in range of the lidar sensor.

10. The method of claim 8, wherein the failure rate is determined for each receiver pixel of the lidar sensor.

11. The method of claim 10, further comprising:
determining a defect or ageing of a respective one of the receiver pixels by comparing the determined failure rate of the respective receiver pixel with determined failure rates of adjacent receiver pixels depending on the distance to the detected object.

12. The method of claim 8, further comprising:
determining a range of the lidar sensor from a reflection intensity of the emitted lidar pulses reflected on the detected object and from the distance of the lidar sensor to the detected object.

13. A method for operating a vehicle or robot, the method comprising:
detecting, by the vehicle or robot using a lidar sensor, surroundings of the vehicle or robot;
determining a degradation of the lidar sensor by
emitting, by the lidar sensor, lidar pulses;
detecting, by the lidar sensor, reflections of the emitted lidar pulses;
detecting an object, from which the emitted lidar pulses are reflected, in surroundings of the lidar sensor;
tracking the detected object over several time cycles;
determining, considering a distance of the detected object to the lidar sensor and a geometry of the detected object, which of the emitted lidar pulses should be reflected on the detected object when the detected object is tracked;
determining a failure rate specifying how often an expected reflection of the emitted lidar pulses reflected on the detected object is not detected within a predetermined period of time; and
determining, based on the failure rate and the distance to the detected object, a degradation of the lidar sensor; and
operating, based on data detected by the lidar sensor, the vehicle or robot in an automatic operation, considering the determined degradation of the lidar sensor.

14. The method of claim 13, wherein the automatic operation is an automatic driving operation in which a driving speed of the vehicle or robot is reduced with increasing degradation of the lidar sensor.
